(19) United States
(12) Patent Application Publication
(10) Pub. No.: US 2024/0033745 A1
(43) Pub. Date: Feb. 1, 2024

(54) Biochemical Analysis Device, Reaction Unit, and Cassette Guide

(71) Applicant: Hitachi High-Tech Corporation, Minato-ku, Tokyo (JP)

(72) Inventors: Bohao CHENG, Tokyo (JP); Hayato SHIMIZU, Tokyo (JP); Toshiki YAMAGATA, Tokyo (JP); Masashi SHIBAHARA, Tokyo (JP); Yoko MAKINO, Tokyo (JP)

(21) Appl. No.: 18/020,683

(22) PCT Filed: Aug. 31, 2020
(86) PCT No.: PCT/JP2020/032850

§ 371 Date: Feb. 10, 2023

(51) Int. Cl. B01L 9/00; B01L 9/06

(52) U.S. Cl. CPC B01L 9/523; B01L 9/06; B01L 2300/14; B01L 2200/141

(57) ABSTRACT

This biochemical analysis device has a configuration in which a reaction unit is installed on a device body, the reaction unit including: a test tube unit having a plurality of test tubes or a test tube unit in which a plurality of test tubes can be installed; a cassette guide; and a cassette box that allows attachment/detachment of the cassette guide. The cassette guide includes a flange part, a ventilation opening provided in the flange part, and a test tube insertion part provided to the flange part. The test tube insertion part is a closed structure, the flange part is installed on the upper surface section of the cassette box, and the ventilation opening suctions air above the flange part via negative pressure generated by an internal space of the cassette box. The foregoing provides a biochemical analysis device in which it is possible to stabilize descending air flow even in a case where a cassette is provided only to a section of the cassette guide, and with which it is possible to easily exchange the cassette guide if the cassette guide becomes contaminated

### TECHNICAL FIELD

The present invention relates to a biochemical analysis device, a reaction unit, and a cassette guide.

### BACKGROUND ART

When genetic information is obtained from a nucleic acid contained in a biological sample for the purpose of clinical medicine or diagnosis, a technique for extracting a nucleic acid molecule from the sample and a technique for quantification by amplification of a target sequence are required. A fully automated genetic testing device configured to automate a series of these techniques is used in a clinical site.

As a nucleic acid amplification technique used to test a nucleic acid, for example, there is a method using a polymerase chain reaction (hereinafter abbreviated as a “PCR method”). The PCR method is a technique configured to use a thermostable polymerase and primers and to amplify a target nucleic acid by raising or lowering a temperature, and is widely used in fields such as genetic engineering and biological testing and detection methods. The principle of the PCR method is to repeat a cycle according to a thermal profile (temperature rise and fall) a plurality of times, the thermal profile being configured to perform temperature control in three steps including a first step of maintaining a temperature at which double-stranded DNA containing a target DNA sequence is dissociated into a single strand, a second step of maintaining a temperature at which forward and reverse primers anneal to the dissociated single-stranded DNA, and a third step of maintaining a temperature at which DNA polymerase synthesizes a complementary DNA strand to the single-stranded DNA, thereby geometrically amplifying target DNA.

Real-time PCR or quantitative polymerase chain reaction (hereinafter abbreviated as “qPCR”) is available as a quantitative test method to which the PCR method is applied. The qPCR method is a highly sensitive gene analysis method, and is being applied to clinical examinations such as quantitative gene expression analysis, pathogen detection, and drug discovery target verification. In the qPCR method, concentration of a target nucleic acid during amplification is indirectly measured by intensity of fluorescence reaction light.

However, a PCR amplification process is sensitive, and even if a very small amount of target DNA derived from a sample other than the sample to be tested is mixed, amplification occurs in the sample that is not to be amplified (hereinafter referred to as “false positive amplification”). This false positive amplification affects accuracy of the fully automated genetic testing device.

When nucleic acid extraction and PCR sample preparation are manually performed, a malfunction in operation causes contamination of a dispensing pipette and a dispensing tip, which may lead to the false positive amplification. Therefore, it is desirable to conduct a test in a clean bench that generates descending and ascending air currents throughout the room. Accordingly, it is possible to discharge aerosol containing a nucleic acid molecule generated during the operation.

In the case of the fully automated genetic testing device, since inspection tests of a plurality of samples are performed in parallel, aerosol and mist generated by high-speed dispensing spread inside the device, which causes cross-contamination between different samples.

U.S. Pat. No. 6,419,827B (PTL 1) discloses a filtration device configured to process a plurality of liquid samples, the filtration device having a configuration in which air and filtrate flow through a filtrate guiding part inserted in a sample well, and the air separated from the filtrate that has flowed down flows out through an aerosol outlet or the like.

US2013/0164853A (PTL 2) discloses a device having a configuration in which the risk of cross-contamination is reduced when disposing of liquid inside an automated analysis system for processing a biological fluid sample, and a contamination prevention shield including a channel for a pipette or a pipette tip is reversibly docked in a liquid waste container.

### CITATION LIST

### Patent Literature

PTL 1: U.S. Pat. No. 6,419,827B
PTL 2: US2013/0164853A

### SUMMARY OF INVENTION

### Technical Problem

In a biochemical analysis device such as a multi-lane type genetic testing device configured to dispose a plurality of reaction lanes and a plurality of dispensing mechanisms in parallel for a plurality of different samples in order to perform a large number of tests in a short time, and to perform a series of operations such as nucleic acid extraction, purification of the extracted nucleic acid, amplification by PCR, and fluorescence detection, it is necessary to prevent microparticles and the like scattered from a sample in a test tube of one reaction lane from being mixed with a sample in a test tube of another lane in order to suppress cross-contamination.

The filtration device disclosed in U.S. Pat. No. 6,419,827B (PTL 1) is not intended to prevent cross-contamination by aerosol on the upstream side of a filter.

The device disclosed in US2013/0164853 (PTL 2) is not a countermeasure against aerosol scattering above the contamination prevention shield, and is not intended to deal with adjacent sample containers.

An object of the invention is to, in a biochemical analysis device, stabilize a descending air current even when a cassette is installed only in a part of a cassette guide, and to easily replace the cassette guide even if the cassette guide is contaminated.

### Solution to Problem

A biochemical analysis device of the invention is configured to allow a reaction unit to be installed in a device main body, in which the reaction unit includes a test tube unit having a plurality of test tubes or a test tube unit having the plurality of test tubes installable therein, a cassette guide, and a cassette box having the cassette guide attachable thereto and detachable therefrom. The cassette guide has a flange part, a ventilation opening part provided in the flange part, and a test tube insertion part provided in the flange part. The test tube insertion part has a closed structure, the flange part is a portion to be installed on an upper surface portion of the cassette box, and the ventilation opening part suctions air above the flange part by a negative pressure generated in an internal space of the cassette box.

### Advantageous Effects of Invention

According to the invention, in a biochemical analysis device, even when a cassette is installed only in a part of a cassette guide, a descending air current can be stabilized.

Furthermore, according to the invention, even if the cassette guide is contaminated, the cassette guide can be easily replaced.

### BRIEF DESCRIPTION OF DRAWINGS

FIG. 1 is an exploded perspective view showing a reaction unit according to an embodiment 1.

FIG. 2 is a perspective view showing an assembled state of the reaction unit according to the embodiment 1.

FIG. 3 is a perspective view showing a cassette according to the embodiment 1.

FIG. 4 is a perspective view showing a cassette guide according to the embodiment 1.

FIG. 5 is a perspective view showing a cassette box according to the embodiment 1.

FIG. 6 is a cross-sectional view showing the assembled state of the reaction unit according to the embodiment 1.

FIG. 7 is an exploded perspective view showing a reaction unit according to an embodiment 2.

FIG. 8 is a cross-sectional view showing an assembled state of the reaction unit according to the embodiment 2.

FIG. 9 is a perspective view showing a cassette according to an embodiment 3.

FIG. 10 is a perspective view showing a cassette according to an embodiment 4.

FIG. 11 is a schematic partial cross-sectional view showing a cassette guide according to an embodiment 5.

FIG. 12 is a schematic partial cross-sectional view showing a cassette guide according to an embodiment 6.

FIG. 13 is a perspective view showing a biochemical analysis device.

### DESCRIPTION OF EMBODIMENTS

The present disclosure relates to a biochemical analysis device. As a specific example, the biochemical analysis device includes, in addition to a genetic testing device, a nucleic acid extraction device, a nucleic acid amplification device, a blood testing device, a biological analysis device configured to test urine, blood plasma, and the like.

### Embodiment 1

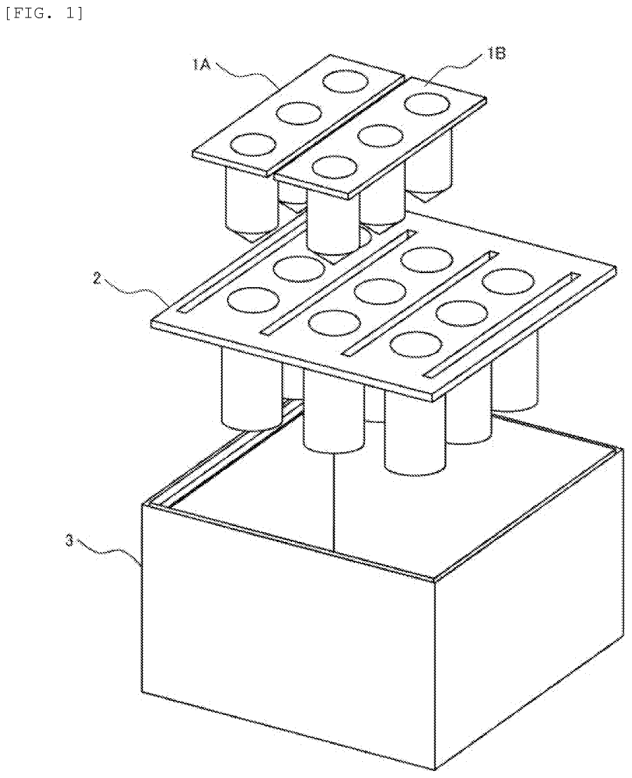

FIG. 1 is an exploded perspective view showing a reaction unit according to this embodiment.

The reaction unit shown in this drawing is a unit including a plurality of reaction lanes, that is, a so-called multi-lane type unit. The reaction unit includes cassettes 1A and 1B (test tube units), a cassette guide 2, and a cassette box 3. The cassettes 1A and 1B are configured to be inserted into a recessed portion of the cassette guide 2. The cassette guide 2 is installed on the upper portion of the cassette box 3. The cassette guide 2 and the cassette box 3 form a cassette stand.

In this embodiment, the reaction unit has three reaction lanes, but the number of lanes is not limited thereto and may be any number. Although materials of the cassette guide 2 and the cassette box 3 are not limited, the cassettes 1A and 1B are preferably made of plastic. Further, in this embodiment, although the recessed portion of the cassette guide 2 is formed in advance, the cassette guide 2 may be manufactured using a material that is easily elastically deformable so as to be elastically or plastically deformed when the cassettes 1A and 1B are inserted thereinto, thereby forming the recessed portion of the cassette guide 2.

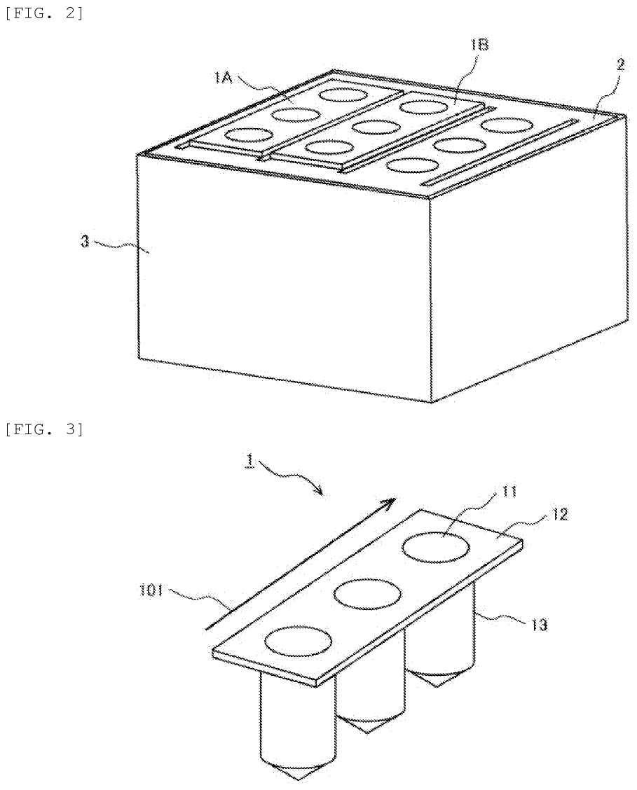

FIG. 2 is a perspective view showing an assembled state of the reaction unit according to this embodiment.

This drawing shows a state in which the cassette guide 2 shown in FIG. 1 is mounted in the cassette box 3, and the cassettes 1A and 1B are mounted in the cassette guide 2.

In summary, the cassette guide 2 can be installed in the cassette box 3. Further, the cassettes 1A and 1B can be installed in the cassette guide 2. FIG. 3 is a perspective view showing one of the cassettes 1A and 1B in FIG. 1.

The cassette 1 shown in FIG. 3 includes three test tubes 13 forming one lane and a lateral flange 12 (lateral flange part) connecting the test tubes 13. The lateral flange 12 is provided with an opening part 11 for each of the test tubes 13. The three test tubes 13 are disposed in the direction indicated by an arrow 101.

Although this drawing shows the case where the three test tubes 13 are provided, any number of test tubes 13 may be provided in one cassette 1 depending on the purpose of use. However, a series of test tubes 13 provided in the same cassette 1 are used only in one test for one sample, and it is desirable that the cassette 1 is discarded after use and a new cassette 1 is used for a new test.

Although the cassette 1 shown in this drawing corresponds to one lane, the same is not limited thereto, and two or more rows of the test tubes 13 corresponding to two or more lanes may be combined with each other to form one cassette.

Further, it is desirable that two cassettes 1A and 1B shown in FIG. 1 are the same.

The above description has been given as to a test tube unit having a configuration in which the cassettes 1A and 1B and the plurality of test tubes 13 are integrated with each other, but the present disclosure is not limited thereto. The cassette may have a plurality of separate test tubes installable therein.

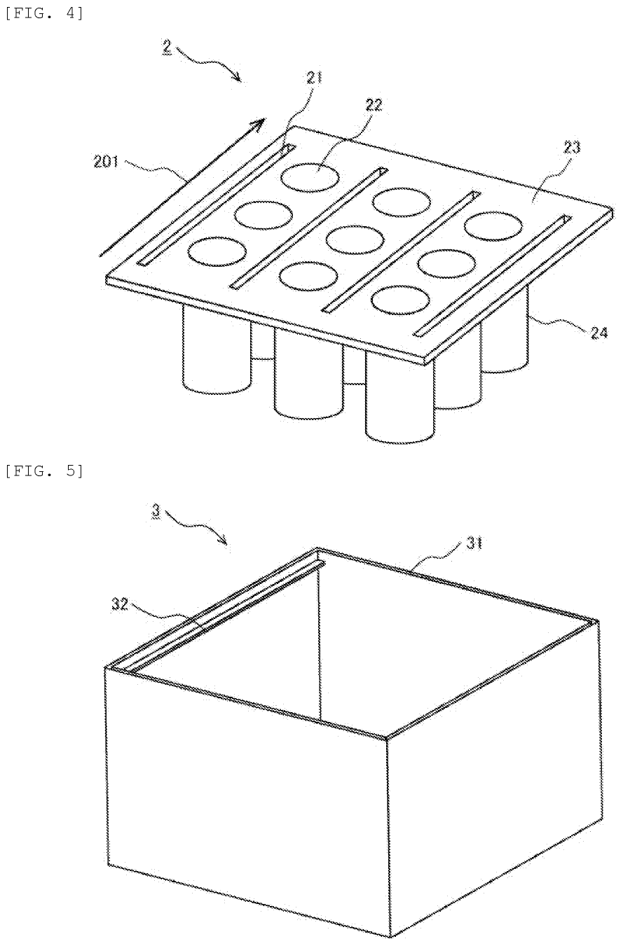

FIG. 4 is a perspective view showing the cassette guide 2 in FIG. 1.

The cassette guide 2 shown in FIG. 4 has nine sheath parts 24 (test tube insertion parts). These sheath parts 24 are connected to each other by a flange 23 (flange part). The flange 23 is provided with an opening part 22 of the sheath part 24 and a suction port 21 (ventilation opening part). The sheath part 24 has a structure in which the same has no portion communicating with the outside other than the opening part 22. In other words, the sheath part 24 has only the single opening part 22 without having an opening part on the side of the cassette box 3, thereby forming a closed bottom structure. The structure of the sheath part 24 can be simply referred to as a “closed structure”.

The suction port 21 penetrates the flange 23.

In this drawing, the suction port 21 has a slit shape and is provided between adjacent lanes disposed in the direction indicated by an arrow 201.

The sheath part 24 has the same shape as the test tube 13 of the cassette 1, and has a shape into which the test tube 13 can be inserted. In a case where the sheath part 24 has exactly the same shape as the test tube 13, when the test tube 13 is inserted thereinto, air inside the sheath part 24 may be compressed, and as such, it may become difficult to insert the test tube 13 thereinto, or the test tube 13 once inserted thereinto may be pushed out by pressure of the air compressed inside the sheath part 24. For this reason, it is desirable to avoid sealing the air by providing a groove or a protrusion at a portion where the sheath part 24 and the test tube 13 are in contact with each other so that the pressure becomes equal to atmospheric pressure. It is also desirable to provide a groove, a protrusion, or the like on either the lateral flange 12 of the cassette 1 or the flange 23 of the cassette guide 2. Further, in this embodiment, although the test tube 13 of the cassette 1 and the sheath part 24 of the cassette guide 2 respectively have cylindrical shapes, the same may have other shapes depending on the purpose of use or the like.

Although this drawing shows a case where the three cylindrical sheath parts 24 are provided in one lane, the present disclosure is not limited thereto. Any number of sheath parts 24 may be provided in one lane according to the number of test tubes 13 of the cassette 1.

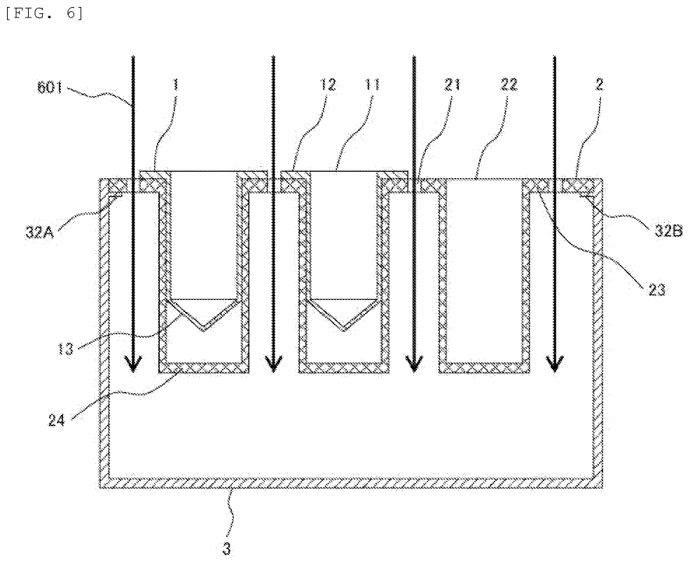

FIG. 5 is a perspective view showing the cassette box 3 in FIG. 1.

As shown in FIG. 5, the cassette box 3 includes a wall structure 31 forming a side surface portion and a bottom surface portion, and a protrusion 32 configured to support the cassette guide 2.

The cassette box 3 has a negative pressure generating unit installed therein such as an exhaust fan or a vacuum pump, the negative pressure generating unit being configured to generate a negative pressure in an internal space surrounded by the cassette box 3 and the cassette guide 2. Although the negative pressure generating unit may be fixed to the cassette box 3, the present disclosure is not limited thereto, and the negative pressure generating unit may be provided outside the cassette box 3. Further, the negative pressure generating unit may be installed inside or outside the biochemical analysis device other than the cassette box 3. Additionally, the negative pressure generating unit is not limited to the exhaust fan or the vacuum pump.

In order to maintain the negative pressure therein, the wall structure 31 has a structure in which the same has no portion communicating with the outside other than the structure necessary for the negative pressure generating unit.

The cassette box 3 has a shape such as a rectangular parallelepiped body, and is a part that supports the cassette guide 2 with the protrusion 32. When the cassette guide 2 is mounted therein, the protrusions 32, protruding inwards and being perpendicular to two facing side surfaces of the cassette box 3, come into contact with the flange 23 of the cassette guide 2 to support the cassette guide 2. When the cassette guide 2 is mounted therein, an upper surface portion of the cassette box 3 is sealed. In other words, the flange 23 can be installed on the upper surface portion of the cassette box 3. Further, in other words, the flange 23 is configured to be fitted to the upper surface portion of the cassette box 3. Therefore, the internal space surrounded by the cassette guide 2 and the cassette box 3 communicates with the outside only through the suction port 21 penetrating the flange 23 of the cassette guide 2.

FIG. 6 is a cross-sectional view showing the assembled state of the reaction unit according to this embodiment.

As shown in this drawing, the cassette box 3 has protrusions 32A and 32B, and the flange 23 of the cassette guide 2 is supported by the protrusions 32A and 32B. The sheath part 24 of the cassette guide 2 has a configuration in which a bottom portion and side surface portions thereof are closed. The suction port 21 is provided in the flange 23 of the cassette guide 2. The cassette guide 2 has no opening part other than the suction port 21. Accordingly, the internal space surrounded by the cassette guide 2 and the cassette box 3 is formed.

Overall, when a plurality of cassettes 1 are mounted in the cassette guide 2, each of the cassettes 1 is configured so as not to cover the slit-shaped suction port 21 of the cassette guide 2.

The internal space is kept at the negative pressure by the negative pressure generating unit such as the exhaust fan or the vacuum pump, and air flows from the suction port 21 into the internal space. In other words, a descending air current in the direction indicated by an arrow 601 is generated.

Such descending air current generates an air curtain effect between the adjacent lanes, thereby making it possible to suppress droplets generated from the test tube 13 from diffusing to other lanes.

Furthermore, the internal space of the cassette box 3 is kept at the negative pressure, thereby also obtaining an effect of bringing the cassette guide 2 into close contact with the cassette box 3.

The descending air current flows into the internal space of the cassette box 3 through the suction port 21 from above the cassette 1 installed inside a device housing, as indicated by the arrow 601. In other words, the descending air current substantially flows into the internal space of the cassette box 3 only through the suction port 21. At that time, droplets or the like (including aerosol and mist) generated from the test tube 13 are transported to the internal space of the cassette box 3, and further, the same are discharged to the outside of the device housing by the negative pressure generating unit such as the exhaust fan or the vacuum pump. In this case, it is desirable to dispose a filter configured to allow an air current to pass therethrough before being discharged to the outside of the device housing, thereby trapping contamination-related particles (such as droplets) and preventing secondary contamination outside the device housing.

The sheath part 24 of the cassette guide 2 corresponds to the cassette 1, and the number thereof corresponds to the maximum number of lanes. During actual use, measurement may be performed with fewer lanes than the maximum number of lanes. Even when only two cassettes are installed in the cassette guide 2 having three lanes as shown in FIGS. 1, 2, and 6, flow velocity of the descending air current is not affected because the sheath part 24 has a closed structure. Therefore, in this case as well, the effect of preventing cross-contamination can be maintained.

Further, according to this embodiment, the cassette guide 2 is replaceable, and as such, even if a reagent or the like adheres to the cassette guide 2, the following analysis can be performed in a clean state.

### Embodiment 2

This embodiment is different from the embodiment 1 in that the cassette box has a top plate, and the other configurations are the same as those of the embodiment 1. Therefore, only the different points will be described in this embodiment.

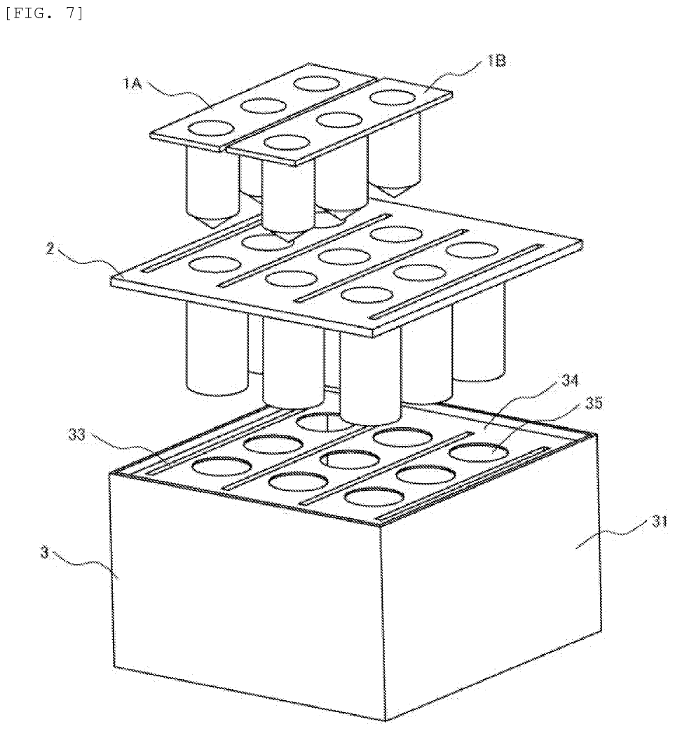

FIG. 7 is an exploded perspective view showing a reaction unit according to this embodiment.

As shown in this drawing, the cassette box 3 includes the wall structure 31 forming a side surface portion and a bottom surface portion, and a top plate 34 configured to support the cassette guide 2. The top plate 34 has a suction port 33 (communication opening part) and a through hole 35.

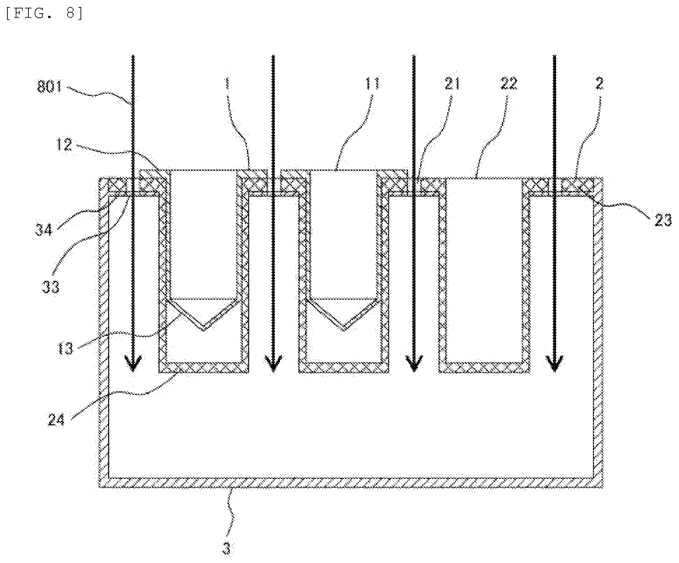

FIG. 8 is a cross-sectional view showing an assembled state of the reaction unit according to this embodiment.

As shown in this drawing, the suction port 33 corresponds to the suction port 21 of the cassette guide 2. As a result, the suction port 21 and the suction port 33 communicate with each other, and when a negative pressure is generated in an internal space of the cassette box 3, a descending air current in the direction indicated by an arrow 801 is generated.

Additionally, the sheath part 24 of the cassette guide 2 is inserted into the through hole 35 (FIG. 7).

In this embodiment, since the top plate 34 of the cassette box 3 supports the cassette guide 2 with its surface, the cassette guide 2 and the cassette 1 can be stably placed as compared with the embodiment 1.

In addition, the negative pressure in the internal space of the cassette box 3 also has an effect of bringing the cassette guide 2 into close contact with the cassette box 3.

### Embodiment 3

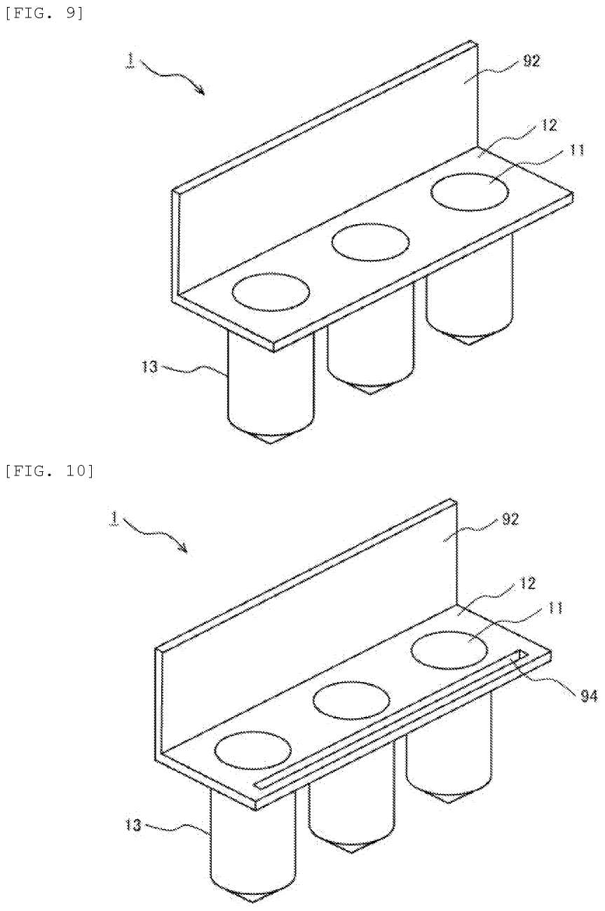

FIG. 9 is a perspective view showing a cassette according to this embodiment.

In this drawing, a vertical flange 92 (vertical flange part) is installed on the lateral flange 12 of the cassette 1. The lateral flange 12 and the vertical flange 92 are perpendicular to each other and form an L-shaped cross section. Accordingly, cross-contamination between adjacent lanes can be suppressed more reliably.

### Embodiment 4

FIG. 10 is a perspective view showing a cassette according to this embodiment.

In this drawing, in addition to the configuration of the embodiment 3, a suction port 94 is provided in the lateral flange 12 of the cassette 1. The suction port 94 corresponds to the suction port 21 of the cassette guide 2 in FIG. 4, and is disposed so that the suction port 94 and the suction port 21 communicate with each other.

### Embodiment 5

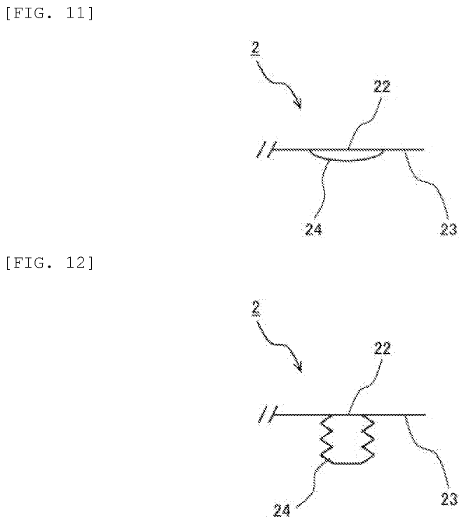

FIG. 11 is a schematic partial cross-sectional view showing a cassette guide according to this embodiment.

In this drawing, the sheath part 24 of the cassette guide 2 is slightly convex downwards. In this case, the depth of the sheath part 24 is shallower than the length of the test tube 13 of the cassette 1. When the test tube 13 is inserted into the sheath part 24, the sheath part 24 is elongated and is deformed into the shape of the test tube 13. As a material for the sheath part 24, an elastic material is desirable. Further, the material of the sheath part 24 preferably has a small elastic modulus. This is because if the elastic modulus is large, an upward force acts on the test tube 13, and the position of the test tube 13 may change during operation. Further, the sheath part 24 may be plastically deformed. Additionally, even in the case where the sheath part 24 is damaged, if the lateral flange 12 of the cassette 1 is configured to be in close contact with the flange 23 of the cassette guide 2, the designed descending air current can be maintained. The material of the sheath part 24 is preferably, for example, polyethylene resin, polypropylene resin, silicone resin, polyethylene terephthalate resin (PET), or the like.

In addition, as a modification according to this embodiment, the sheath part 24 may be formed in a flat shape instead of protruding downwards, and may be parallel to the flange 23.

When the sheath part 24 is designed to be damaged, a sharp portion such as a blade may be provided at the lower end of the test tube 13 so that the sheath part 24 is damaged when the sharp portion contacts the sheath part 24. The sheath part 24 may be a film shape.

In this case, when the lateral flange 12 of the cassette 1 is not in close contact with the flange 23 of the cassette guide 2, it is considered that the descending air current flows into the internal space of the cassette box 3 not only through the suction port 21 (in FIG. 4) but also through the damaged portion of the sheath part 24. However, since the damaged portion has a small gap and is positioned at the peripheral edge portion of the test tube 13, it is considered that the descending air current still has an effect of preventing contamination.

### Embodiment 6

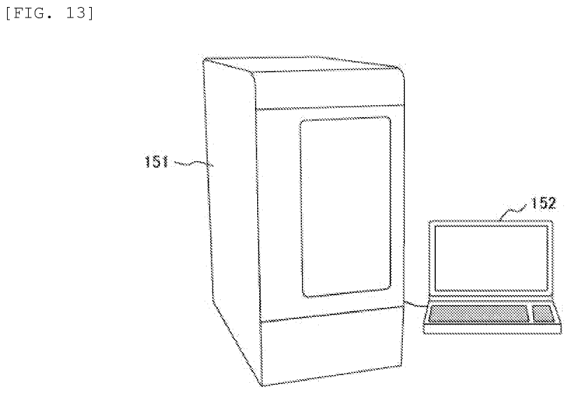

FIG. 12 is a schematic partial cross-sectional view showing a cassette guide according to this embodiment.

As shown in this drawing, the sheath part 24 may be formed in a bellows shape with a bottom portion closed. When the test tube 13 is inserted into the sheath part 24, the bellows of the sheath part 24 is configured to be elongated and deformed. This is considered a type of plastic deformation.

The embodiments 5 and 6 are briefly described as follows.

The sheath part 24 may have a configuration in which the sheath part 24 is deformable when the test tube 13 is inserted thereinto, or a configuration in which the sheath part 24 becomes an open state when the test tube 13 is inserted thereinto.

A biochemical analysis device will be described below with reference to the drawings.

FIG. 13 is a perspective view showing an example of the biochemical analysis device.

In this drawing, the biochemical analysis device includes a device main body 151 and a control terminal 152. The reaction unit described above is installed inside the device main body 151. A part of the reaction unit can be seen from the window of the device main body 151. In the control terminal 152, a user can appropriately confirm and input operating conditions or the like of the device, and can confirm the display of inspection results or the like.

It is noted that an operation panel having a function of the control terminal 152 may be installed in the device main body 151.

Effects of the invention will be collectively described below.

According to the invention, the inside of a cassette stand is made to have a negative pressure, and a descending air current flowing between adjacent lanes from above a cassette guide is generated through a suction port appropriately provided in the cassette guide. Accordingly, even if a reagent or a sample in a cassette becomes aerosol or mist during analysis operation and scatters around the periphery, the same is collected inside the cassette stand. Accordingly, it is possible to prevent cross-contamination of the reagent or the sample.

In addition, by using the cassette guide which is a part separate from a cassette box, even when the cassette is not mounted, a flow path for the descending air current can be limited to the suction port provided in the cassette guide. Therefore, the inside of the cassette stand, including a hole into which a test tube of the cassette is inserted, can be isolated from the internal space of a device housing. Further, when only a part of the lanes are used or when the cassette of the individual lane is replaced, it is possible not only to maintain flow velocity of the descending air current, but also to stably maintain the descending air current.

Furthermore, the cassette guide is replaceable, and the same is appropriately discarded and renewed, thereby making it possible to prevent secondary contamination due to adherence of aerosol or mist.

When aerosol or mist scatters and spreads from the inside of the test tube of the cassette, or even when mist is generated from the tip portion of a dispensing tip and the mist scatters, the aerosol or the mist can be collected in the same lane, thereby having an effect of preventing cross-contamination. Accordingly, analysis accuracy of a biochemical analysis device having a plurality of reaction lanes can be improved.

### REFERENCE SIGNS LIST

1, 1A, 1B: cassette
2: cassette guide
3: cassette box
11: opening part
12: lateral flange
13: test tube
21: suction port
22: opening part
23: flange
24: sheath part
31: wall structure
32, 32A, 32B: protrusion
33: suction port
34: top plate
35: through hole
101, 201, 601, 801: arrow

1. A biochemical analysis device configured to allow a reaction unit to be installed in a device main body, wherein the reaction unit includes
a test tube unit having a plurality of test tubes or a test tube unit having the plurality of test tubes installable therein,
a cassette guide, and
a cassette box having the cassette guide attachable thereto and detachable therefrom,
wherein the cassette guide has a flange part, a ventilation opening part provided in the flange part, and a test tube insertion part provided in the flange part,
wherein the test tube insertion part has a closed structure,
wherein the flange part is a portion to be installed on an upper surface portion of the cassette box, and
wherein the ventilation opening part suctions air above the flange part by a negative pressure generated in an internal space of the cassette box.

2. The biochemical analysis device according to claim 1, wherein the cassette box has a protrusion configured to support the cassette guide.

3. The biochemical analysis device according to claim 1, wherein the cassette box has a top plate configured to support the cassette guide,
wherein the top plate has a communication opening part and a through hole, and
wherein the ventilation opening part and the communication opening part communicate with each other.

4. The biochemical analysis device according to claim 1, wherein the ventilation opening part has a slit shape parallel to a lane of the test tube unit.

5. The biochemical analysis device according to claim 1, wherein the test tube unit has a lateral flange part configured to connect the plurality of test tubes.

6. The biochemical analysis device according to claim 5, wherein the lateral flange part has a vertical flange part.

7. The biochemical analysis device according to claim 6, wherein the lateral flange part and the vertical flange part form an L-shaped cross section.

8. The biochemical analysis device according to claim 1, wherein the test tube insertion part is made of a material deformable when the test tube is inserted thereinto, or a material that becomes an open state when the test tube is inserted thereinto.

9. A reaction unit comprising:
a test tube unit having a plurality of test tubes or a test tube unit having the plurality of test tubes installable therein;
a cassette guide; and
a cassette box having the cassette guide attachable thereto and detachable therefrom,
wherein the cassette guide has a flange part, a ventilation opening part provided in the flange part, and a test tube insertion part provided in the flange part,
wherein the test tube insertion part has a closed structure,
wherein the flange part is a portion to be installed on an upper surface portion of the cassette box, and
wherein the ventilation opening part suctions air above the flange part by a negative pressure generated in an internal space of the cassette box.

10. A cassette guide installed in a cassette box and configured to allow a test tube unit having a plurality of test tubes or a test tube unit having the plurality of test tubes installable therein to be installed therein, the cassette guide comprising:
a flange part;
a ventilation opening part provided in the flange part; and
a test tube insertion part provided in the flange part,
wherein the test tube insertion part has a closed structure,
wherein the flange part is installable on an upper surface portion of the cassette box, and
wherein the ventilation opening part suctions air above the flange part by a negative pressure generated in an internal space of the cassette box.

11. The cassette guide according to claim 10, wherein the test tube insertion part is configured to be deformable when the test tube is inserted thereinto.

12. The cassette guide according to claim 10, wherein the test tube insertion part is configured to be in an open state when the test tube is inserted thereinto.

13. The cassette guide according to claim 10, wherein the test tube insertion part contains polyethylene resin, polypropylene resin, silicone resin, or polyethylene terephthalate resin.
